(19) United States
(12) Patent Application Publication
(10) Pub. No.: US 2009/0098526 A1
(43) Pub. Date: Apr. 16, 2009

(54) Systems & Methods for Improving Academia

(76) Inventor: AHMAD AMIRI, RICHMOND HILL (CA)

Correspondence Address: AHMAD AMIRI, 21 DUNLOP ST., # 207, RICHMOND HILL,, ON, L4C 2M6, omitted

(21) Appl. No.: 12/249,748

(22) Filed: Oct. 10, 2008

Related U.S. Application Data
(60) Provisional application No. 60/979,820, filed on Oct. 13, 2007.

(51) Int. Cl. G09B 25/00; G09B 19/00

(52) U.S. Cl. 434/365; 434/247

(57) ABSTRACT

Systems & Methods for Improving Academia is a Universal Open University, an on-line forum, exchange and market enabling all academic players to present their services and all learners to learn and receive qualifications. It is Universal, covering all students, all teachers, all players, all topics, all levels, all methods, all else. It is Open, to all learners, teachers and other players, no prerequisites, no traditional walls, no barriers. It is a University, facilitating all academic activities, aiming for excellence with a range of qualifications. Academic Players (AP) that can benefit from UOU include, Students, Parents, Professors, Tutors, Testing Services, Universities, Employers, Career Consultants, Rating Agencies, Associations, Unions, Governments, etc.

Some of many Problems with conventional ( traditional, open and web) universities are:
They “reject” many who apply to study, which is totally unacceptable, as almost all limited resources which someday justified limited intake ( shortage of teachers, physical facilities, funding, etc. ) can all be resolved as will be seen in this application.
They impose prerequisites for many courses, barring many, rather than inviting all to learn.
They employ teachers, having little knowledge of how good a teacher their choice is. Selection is typically based on candidate's past academic performance, publications and university politics. Empathy with novice, as a major ingredient of teaching skills, is almost never appraised.
They offer courses and design their syllabus, with only minor, indirect and usually outdated understanding of what the students want to learn, what employers need or other enquiry.
They teach at same intellectual level for all, which makes it impossible for some, who drop out.
They teach at a one for all pace which is too fast or slow for many.
They test students themselves, usually without independent oversight, often subjectively, influenced by sympathy, relationships, bargaining, cheating, etc.
They have unfair and incomplete testing systems using:
a—too few questions, covering part of the syllabus, unfair to those who learnt most but that part
b—all hard questions, failing most, making no distinction between various student levels
c—all easy questions, enabling many to score 100% without differentiation
d—subjective testing, affected by irrelevant factors such as examiners mood
e—multiple choice or descriptive testing only but not both, unfair to those who are not easy with one
f—rarely used topics, s.a. some language tests focusing on rarely used words, g— . . .
They use crude grading, D− to A+, some mainly B− to A+, rather than 0-100%.
They often have irrational cut offs and compiling of results, say scoring 65 is a C but 66 is a B, which is given a much higher weight than C, turning the one percent difference to a life changing one.
They have no universal grading, hence a D in one university can be well above an A in another.
They have a binary qualifying system, one either has a bachelors degree or not, and passing 99% of credits for a degree is of little value.
They are accredited by government or association beaurocracies, by passing legitimacy and minimum standards, such that accredited does not imply quality and that good but unconventional entities fail along with fraudsters.
They are not gradable themselves, so that choosing say the best university to learn mathematics is not easy, except for some subjective rankings done with limited data, lacking professors' detailed resumes and teaching skills.
They are packaged, discouraging students to learn maths in one university and physics in another.
They are designed for a certain age, treating continuing education as a low priority peripheral for applicants who were not good enough to finish in time, not those so good that never stop learning.
They use many irrelevant student selection criteria, giving points to sport stars, foreigners, minorities, employees, donors, diplomats, rich, upper class, etc.
They are inflexible, such that a student trapped in their often arbitrary patchwork of regulations, has little recourse or alternative. Take it or leave it attitude prevails.
They are autocratic, closed clubs, rooted in tradition, designed to resist change from within or without, looking almost like what they did centuries ago, despite progressive endeavors.
They are often funded by public or endowment and need not meet any performance criteria.
They follow primary school, secondary school, university model, so that one has to spend several years to the next level, and 12 years of education is same as 15, which is far below 16 years.

Solutions:

Solutions offered here, can be implemented without reliance on the Internet, but one best way of practicing them is through one or more Web based exchanges, which bring together many of the players and systems required, a typical one to be called Universal University Website (UUW). Whenever UUW is used, it will mean the system including one or more websites which serve as portals or exchanges for all users, service providers and players executing hereby solutions. The word university is used here generically, but concepts apply to schools, high schools, etc.

Freedom to Suggest Courses

Anyone, including the following should be able to suggest a course, and post it on UUW:
a student who wants to learn say “architectural design”
a parent who wants his child to learn some specific subject
an employer who needs or anticipates need for certain skills
a career consultant
a university
a teacher who believes what he can teach is valuable to some
an association, trade union, or the like, persuing some goal
a government promoting certain policy

Freedom to Suggest Syllabi for a Course

Anyone should be able suggest a syllabus for posted courses and post it on UUW. A course can have many different syllabi, emphasizing different approaches, methodologies, emphasis, progression, levels of difficulty, for different prior backgrounds, different utilizations, etc.

Of importance is having a range from easy, elongated, illustrated, . . . for the novice, to condensed, dry, rigorous, . . . for fast learners and those with prior training. Failure to provide this range is where the traditional education disappoints almost everyone. Expecting all to jump over the same barrier is boring for some and degrading to many who will later be called “drop outs ”. Dividing even a high barrier to smaller steps enables everyone to pass, some in one jump, some in many steps, but no failures.

Conventional universities assume that a student is in no position to suggest a course or syllabus. Suggesting what to learn, in what order, how fast, and from which starting point should be the students' prerogative, rather than a dictated policy.

Freedom to Teach

Anyone should be allowed and enabled to teach a course and related syllabus. We can all teach. This does not mean any teacher should be paid by public funds. Governments and other educational funders can fund only approved students, taking approved courses taught by approved teachers, etc.. Teaching can be via any media, but UUW enables teachers in many ways.

Each teachers' C.V., sample teaching material, hand outs and other info can be posted.

Freedom to provide educational and testing material and facilities is inherent in freedom to teach.

Service Providers can authenticate said C.V.s, survey students, grade teachers, set up blogs and offer other aids to choosing one from a number of teachers for the same course and syllabus.

For interactive teaching and tutoring, available time segments should be rationed, by some criteria to reduce the number of students per time slot per teacher/tutor to a manageable number. Rationing criteria can be on-line auctioning, pricing, merits and/or other.

UUW provides for Internet and other modes of delivery of archived material, live broadcast, one way and interactive real time or delayed communication, between teachers and students. It also facilitates payments for all material and services. Teaching, Services and UUW can charge users, be free, take advertising revenue, etc.

Freedom to Test & Grade

Anyone should be allowed and enabled to test ones knowledge, using test material created by same tester or by others. Examples are:
specialized testing services such as those conducting GRE, GMAT, LSAT, CLEP, SAT, . . .
a person testing herself, unmonitored, for self assessment
those who suggested the course or syllabus which is being tested
those who taught the course being tested
any of those groups who teach
any of those groups who suggested courses and/or syllabi
those providing educational and/or testing material

Testing can be supervised in physical facilities ( conducted on-line, on paper or verbally) or conducted on-line (written or verbal) and supervised using on-line cheat proofing technologies, or in other ways.

Descriptive, multiple choice, or other forms of testing can be used.

Same person can be tested in many ways for the same syllabus, to give the examinee, an employer or others a better view of her strengths, say if she does better on interview, multiple choice or descriptive.

All problems with conventional testing and marking methods, some listed here can thus be corrected. Examinees have the choice of avoiding unfair testing methods.

Another issue solved is that many good students perform poorly on say multiple choice, but can be good in say descriptive exams. Multiple approaches provide all choices. In addition, each exam method has it own merits. E.g. multiple choice enables numerous questions, from easy to difficult, covering all of the syllabus, while interview exams test interactive abilities.

Testing independent of teaching institution enables students from different universities to take the same test and hence the results are universal, not university dependent.

Also anyone suspecting that a good mark was the result of favoritism can demand a retake. Conventionally, a student, especially if studying for a degree, can take a test only while studying. Asking her to retake the test some years later is impractical. A potential employer cannot prove favoritism and has to make the wrong choice or be accused of discrimination. Making testing independent of teaching, offered by many in many places and times solves many issues.

Freedom to Take Tests

Tests can be offered to anyone willing to take it. This does not mean that any testing institution should be compelled to accept any examinee, but most will have no reason to bar a paying examinee.

Artificial and unnecessary Prerequisites can be lifted. If one wishes to take an exam in fluid mechanics, why not, even if cannot prove any knowledge of applied maths, especially if she is not subsidized, and testing resources are not constrained. One will not normally take a test without good cause. Decimal scoring, say −100 to +100, 0 to 9, etc. helps universality and comparability. UUW enables testing entities to test anyone they wish and anyone to take any test offered to them.

### General Testing

Testing need not be associated with any syllabus or course. Aptitude, skill, prior knowledge and many other traits can be tested. It should be possible to earn a qualification based on tests of one's knowledge regardless of where or how learnt.

### Transcripts

Student Transcripts can contain details such as courses, syllabi, when, where, how many times taken, teaching institutions, teachers, teaching methods used, etc. More importantly tests taken, by whom, when, how many times, by which methods, under physical monitoring or on-line, if on-line which cheat proofing technology used, scores at each test, etc.

Transcripts can be digital, hypertext, interlinked and/or even web resident. They can have passwords, tamper proofing and other security features. They can be suitable for computer manipulation.

Freedom to Confer Qualifications (Certificates, Diplomas, . . . , even Degrees)

Qualifications are a summation of courses and tests taken successfully and recorded in transcripts. Thus anyone should be able to offer and support them. Examples:
any of those eligible to take tests, including but not limited to universities
a student offering herself a degree in mathematics, supported by scoring above 85% of maths graduates taking the Graduate Record Exam (GRE)
an employer issuing a diploma to self learner employees, based on tests offered by an educational testing service
a conventional university issuing degrees based on attendance, courses, homework, tests, theses and other criteria, all at the same university

Each Qualifying body can list and publish its requirements for each of the qualifications it offers. Example: “Qualifying Institute . . . ” offering a Mathematics degree by requiring above 65 percentile in twelve topics tested by “Mathematics Institute of . . . ”, no test taken more than three times nor less than twice, using the average of best two test results, at least one should be multiple choice.

Freedom of Research

Same freedoms can apply to research, so anyone can:
propose a research topic, e.g. a physician noticing something in her patients
be a candidate to carry out a proposed topic, e.g. a doctoral applicant
be a candidate to supervise a proposed topic, e.g. a professor
be a candidate to assist a research, e.g. a masters degree applicant
be a candidate to review and mark a theses, e.g. a ministry of health
confer research degrees, e.g. Heart Association of . . .

Rating, Accreditation & Ranking

Internet and other means can be used to “rate” any player, including course or syllabus designers, teachers, teaching materials, tests, testing bodies, qualifying institutions and “qualifications”.

Ratings can be done by governments, accreditation boards, rating agencies, employers, peers, students, etc. as raw data for Accreditation (minimum standards), Approval (e.g. for funding), Ranking (e.g. for employers).

Decimal rating measures can be used to ease comparisons. Software friendly wordings of such ratings, e.g. XML can help automating the rating process. Various algorithms can be used for weighting, summation and interpreting the rating raw data.

Of importance is ranking of the “qualification”, for owners, employers, funders, society and others. This also tags degree mills offering degrees of no substance.

Individual student data can be available on-line in name disguised form, to allow follow up measuring. Evaluation of future performance of students who took a course, taught by a teacher and tested by an examiner can be used to rate all above.

Employment Search

Creating data bases of student transcripts, rating and rankings of teaching, testing and qualifying institutions and other relevant information enables easier and more comprehensive searching for an employer, using search engines and bots.

Having data prepared from scratch to be uniform (for example decimal marking, instead of A, B, . . . ), and all other data input in XML or other computer ready format, enables very intelligent searches.

None has to compromise privacy, as data can be stored anonymously. Only when a suitable candidate is found, her name and contact info may be revealed. Even then, data base custodians can inform the candidate to contact the employer rather than revealing names or personal data to employers.

Funding & Other Limited Recourses

Conventionally, admission restrictions and prerequisites are imposed due to funding and other limitations. In particular government grants and campus size meant rejection of many applicants. UUW facilitates unlimited virtual campus space and teaching resources.

However, governments and other funders can use all the raw data, ratings, accreditation and rankings to select which students to fund. Ditto for other limited resources such as hospital internship for medical training, physical labs, campus study for those who prefer it, etc.

Most services such as teaching, testing, qualifying and facilitators such s UUW will be for fees. Funders can choose which services and users to.

Unique Degrees & Qualifications

Many types of degrees and qualifications can be conferred, examples:
B.A. to a high quality literary writer, song writer, film director
M.Sc. to someone writing a book researching a hypothesis
Ph.D. in Innovation to an Inventor of an important device

It is unfair that unless commercially successful, such people are rarely recognized, yet many conventional degree holders know, perform and contribute less than above examples. High academic and artistic achievement or contribution, should be recognized, regardless of commercial success.

Virtualizing the Physical Campus

Almost all campus facilities can be on-line, some better than physical form. Examples:
Interactive, even live and real time communication with a tutor
Web conferences, debates, news groups, . . .
Social networking, such as in MySpace
Second Life type virtual 3-D campus
On-line dating,seeing and talking while eating, as a dinner outing
Peer to peer networking and academic help
Diagnostic viewing of sick child's throat, skin color, heart rate all on-line
Surgery broadcast to remote students
Robotic surgery on-line, assisted by remote medical student
On-line musical instruments, enabling real time practice with a remote instructor
On-line project collaboration

An example of a job better performed on-line is project collaboration, where all files and applications are on a server, allowing all to access and participate concurrently, not possible on a black board.

Note that 3-D viewing on 2-D screens is possible now and cubic 3-D monitors are coming.

Authentication Services

Students and other users will assess teachers and other providers based on on-line credentials. Authenticating merits of on-line players scattered all over the world is a much needed service. Authentication services can play that role, offering their services for a fee, advertising revenue or other gains, validating physical and on-line documents, kept in various parts of the world.

Alternative Medical Education

An example of the impact of educational freedoms proposed here is medical education. Conventionally, few are allowed into medical schools, who suffer years of hard work, during which time they have low status and low salary. The rational is to train better doctors for a better health service. The effect is the opposite, too few doctors who are too expensive to cover a great majority of the population. The system proposed here enables anyone to pursue medical training. While studying they can be used as “assistants” or “nurses” within a couple of years, then diagnostic screeners to differentiate viral flu from bacterial infection and even prescribe low risk anti biotics, and so on. They can work and study, leading to much better doctors.

So long as their transcripts are transparent to all users, so that their level of expertise and rankings are easily and quickly accessed, and so long as no one is legally compelled to use a low grade doctor, having a semi-doctor for a remote region of a poor country is always better than none. For most trivial deseases, young enthusiastic students can be better than one worn out from years of hard work.

Universal University Website

UUW is an imaginary website to illustrate implementing the systems and methods proposed here. Proposed courses are posted on UUW. Syllabus designers propose various syllabi for each course. Teachers list themselves to teach each course. Teaching material providers list their wares. Testers list what courses or other abilities they test. Qualifying institutions list their criteria for conferring degrees. Rating agencies provide their appraisals of teachers, materials, testers, tests, qualifying bodies, etc.

UUW, its sub-sites and/or providers enable on-line and physical delivery of archived material. Communication means of all forms, e-mail, instant message, text message, telephone, videophone, broadcasting and interactive, even live and real time are enabled.

UUW maintains various data bases, such as student transcripts, ensuring their integrity, security, and required level of privacy, yet access by authorized users. UUW facilitates payments for services by users, and also charges for its own services. Not all services need be performed under one UUW. UUW can serve as the advertising and sales portal for providers of off-line services too.

De Facto Live Broadcast

Most educational materials, including lectures and tutorials can be archived for delivery on demand. Occasionally live broadcast provides better results, but strains Internet communication networks. Viewers or listeners would not notice a video or audio transmitted with some delay will appear live.

Breaking a live session into archived segments and then broadcasting them in original sequence, with some unnoticeable delay reduces transmission problems without loss of real time perception. This has applications outside on-line universities. A basketball game, if shown with say fifteen minutes delay will be no different than real time to viewers, unless they watch it live on TV concurrently. Transmission in de facto live as explained reduces costs and increases video quality.

One feature that must be incorporated is a single payment or license to download to cover all segments, so that users do not have to pay separately for each segment. Even though each segment is archived separately, their ref numbers or file names can be linked so that one license to download sequentially downloads all as a single session.

Physical Facilities

Some functions are better delivered in physical (non virtual) facilities. Some students can learn better if a teacher is close, or in the company of peers. Most exams better be supervised physically even if conducted on-line. It helps to meet teachers and other students. Some lab work is not practical on-line.

Such services can be offered by providers of physical facilities, though not necessarily all by the same provider. They may be dedicated facilities or rented for the occasion. For example seminars can be arranged in rented space. Group field trips can be organized. Lab and hospital facilities can be leased. Hotels, auditoriums, music halls . . . can be used.

Also dedicated campuses can be set up to provide whatever is better done on campus. Contrary to first impressions, virtualization of academia, for what better be done on-line and for what campus space is not available, increases campus services and enables more entry into campus.

Conventionally, setting up a campus requires a huge investment, which may not pay off. One campus needs to cater to student selection, teaching, testing, qualifying, dorms, food, recreation, and more. Thus the smallest authentic university needs hundred of staff and a large campus. Too big a venture.

Systems and methods suggested here distribute various functions to various providers, each simple enough for a typical entrepreneur to handle, with ample information as to the potential demand.

A businessman establishing a cafeteria as a meeting place for those taking similar courses on-line and living in same locale will have access to ample data to choose the right location and even email potential patrons. A sports facility can dedicate its day hours to on-line students to play together.

Campus teaching can be provided by those who can rent a proper building, without any worries of failing accreditation, selecting students, examining, etc. Such a campus may even show on-line lecturers on large classroom screens, but have physical tutors, and supervise examinations. Providers can organize various off-line activities such as group field trips, dinner gatherings, galas, sports events, dances, concerts, political demonstrations, and more, for students and teachers of some common interest, especially for those living in proximity of some event.

Even current campuses can perform much of their functions on line, say via UUW. So their physical facilities can handle much more of the work that better be off-line. Result is a substantial increase in the number of students they can accept. UUW enables campus to do more for more students.

Universal Open University (UOU)—A Summary

UOU is an on-line forum and market, enabling all academic players to present their services and all learners to learn and receive qualifications.

It is Universal, covering all students, all teachers, all players, all topics, all levels, all methods, all else. It is Open, to all learners, teachers and other players, no prerequisites, no traditional walls, no barriers. It is a University, facilitating all academic activities, aiming for excellence with a range of qualifications. Academic Players (AP) that will be able to benefit from UOU include, Students, Parents, Professors, Tutors, Testing Services, Universities, Employers, Career Consultants, Rating Agencies, Associations, Unions, Governments, etc.
Any AP may propose a course, and post it on UOU, especially if it is not offered anywhere. Academic players need not wait in anticipation that some university may someday propose it.
Any AP may design a syllabus, for proposed courses, and post it on UOU. For the same course, there can be many syllabi addressing a range of students, rigor, emphasis, intensity, duration, etc.
Any AP may teach a designed Syllabus, via UOU or benefiting physical facilities. Not all teachers will be in demand, but no one should be denied the opportunity.
Any AP may tutor a limited number of students at each session, one to one or one to few coaching.
Any AP may Test & Mark, in particular, educational testing services, universities and employers may use UOU to test on-line or to register and coordinate off-line tests.
Anyone may take any test, regardless of where, when or how the knowledge was acquired. Conducted online or in a facility, via UOU, tests can multiple choice, written and/or verbal.
Anyone may Undertake Research, Supervised or not, and post it on UOU for peer reviews.
Any AP may Confer Certificates, Diplomas, Degrees, based on II Transcripts”, which detail Exams, Research, Inventions, Writings, Artwork.

No Monopoly: Same Player may but need not play all above roles. Teacher need not be Examiner.

Campus Activities can almost all be virtualized, examples:
Interactive &|or Real time Voice &|or Video Communication &|Collaboration Web Conference,
Debates, Forums, News Groups, Social Networks, Dating
Second Life type of 3-D Virtual Campus
Musical Instructions, via on line instruments
Surgery broadcast to many medical students
Diagnostic Teaching by broadcasting medical probes and gauges with diagnosis
Remote Surgery, assisted by Trainees

Other Providers that will be able to use UOU include:
Transcript Hosts, hosting databases of students, courses & syllabi taken, exams, examiners, grades, class averages, population averages, number of attempts etc., each Student.
Authentication Services, to authenticate teachers and other players backgrounds and claims.
Funders, offering their grants, scholarships and loans based on transcripts.
Recruiters, searching Transcript Databases to match them with employers and funders.
On-line Training Programs & Universities, using UOU, instead of starting from scratch.
On-Line Providers, of a range of related services.
Rating Agents, to Rate teachers, tutors, courses, syllabi, examiners, tests & qualifications.
Accreditors, using Ratings and other data to accredit or discredit qualifying bodies. Governments, Associations, Employers, Universities, Teachers Unions, Guilds can all participate.

Some mostly off-line services include:
Lessors, providing physical space for exams, meetings, classes, etc.
(Research) Labs, (Training) Hospitals and similar facilities with no proper virtual substitute.
Conventional Universities, using UOU for their on-line courses.
Organizers, of off-line activities, such as sports, field trips, dinners, conferences, etc.

Tutoring: We have discussed on line teaching. We have also discussed teaching from by one teacher to one student or one to few, so that interaction between teacher and student(s) is possible. We have also discussed auctions, pricing or selection criteria for reducing the number of students to a level that makes interaction between teacher and student possible.

For clarity, we will use teaching to mean lecturing, one to any number, as students or audience do not expect to interact with the teacher, say ask questions as the lecture during a lecture.

We will use Tutoring for when number of students and communication facilities enable such interaction.

Structure: UOU will provide the Platform for all Academic Players & Providers, but will not be a player. UOU will give everyone, not just itself, the tools to be a player. UOU Affiliates will become Academic Players & Providers, as Examples, Innovators, Leaders & Seeders. UOU will also try to sensor trash. UOU and others may provide their services free, for advertising revenue, for subscription, per use, etc.

### EXAMPLE

A philanthropist with wishes to help remote African villagers with their health.

She can only afford time, but has no medical degree & knows that 95% of villagers needs are basic.

She proposes a course on UOU, for basic diagnosis, treatment and referral training.

A number of doctors and educators may propose different syllabi for the said course.

Syllabi range from two years to five, so she chooses the shortest one.

A number of educators may offer to teach the syllabi, and provide educational material.

Some Educators may pay a Rating Agency to Rate their Profile and Syllabus.

Some Student groups may pay an Authentication Service to check on Teachers Resumes.

A number of students may register for each of those Syllabi and learn on line.

A number of Examiners, including the Teacher may give Tests and Grade the them.

An Entity, such as Doctors Without Borders, may offer a Certificate in Basic Diagnosis & Treatment, based on the Syllabus, Teacher's Authenticated Background, Rating, Exams, Examiner, Grades, etc.

A Rating Agency may Rate the course by polling Students, Teachers, Villagers and Doctors.

A government may give Doctors Without Borders Accreditation, to issue said Certificate, to others. Ditto for other Players, Providers, Students & Beneficiaries.

A brief of some of the ideas disclosed follows.

1—A method of facilitating and improving academic activities having the steps of:
setting up an Internet based exchange;
said exchange enabling a number of categories of academic players to perform activities;
said exchange enabling a set of said activities chosen from a list;
said list including at least, (a) suggesting a course of study, (b) designing a syllabus for a course, (c) teaching a course, (d) tutoring a course, (e) conducting a test, (t) taking a test, (g) proposing a research topic, (h) conducting research, (h) supervising a research, (i) examining a research and (j) conferring qualifications;
each player need not perform more than one of said activities;
said players need not be affiliated with a recognized establishment to perform a sub-list of above list;
said sub-list includes at least one of activities chosen from (a), (b) and (g); and
said set of activities include at least one from (a), (b) and (g).

2—Method in 1 where said activities list also includes at least (k) hosting of student transcripts, (l) hosting of other data related to a player or activity, (m) authentification of data provided by a player, (n) funding of a player or activity, (o) recruitment for a player or activity, (p) rating an activity or player and (q) accrediting a player or activity.

3—Method in 1 where said activities list also includes at least, (r) organizing off line or physical activities, (s) providing physical space for performance of off line activities, (t) providing a physical lab and (u) providing physical training facilities.

4—Method in 1 where a tutor's time slot is allocated to a limited number of students via a number of following methods, (a) auctioning said time slot between all student applicants, (b) pricing said time slot high enough to reduce paying students to or below said limited number, (c) setting criteria to reduce eligible student to or below said limited number.

5—Method in 1 where a number of players try to make financial gain from said activities.

6—Method in 1 executed via a system having a website, each of said players having a web accessing device, said players having access to said website via electronic communication links.

7—Method in 6 where a number of players are enabled to have direct communication with a number of other players, even off said website.
8—A method of delivering live and real time content from a source over the Internet to a receiver, having the steps of:
digitizing said content at source into separate time slots in real time sequence;
storing each slot into a dedicated file;
each file's size defined by a criterion chosen from a list, which list includes at least, (a) predetermined duration the file's live version takes, (b) a predetermined volume of digitized data it teh file, (c) the earlier that criterion “a” or “b” becomes true during digitizing and (d) the later that criterion “a” or “b” becomes true during digitizing;
providing a serial code signifying the order in real time the live version of said file occurred;
archiving said files;
delivering each file to the receiver via the Internet, using methods of delivering archived content;
ensuring that each file the can consumed only after a delay after it is received;
said delay is sufficient for each file to have been received before consuming said file starts;
which sufficiency is calculated from the delivery speeds prevailing during said content delivery;
ensuring that received files are consumed in the order their content occurred in real time; and
minimizing the time gap between ending consumption of one file and starting the next,

whereby content delivery is achieved lower costs and higher quality of achieved compared to live delivery, yet said delay is unnoticeable and the content appears live at consumption, whereby a typical use of said method can be delivery of live lectures to students for improving academia.

9—Method in 8 where a license is needed to consume said received content, providing each of said with an identification code which is the same foe all files originating from said content, which license enables consumption of any file having said identification code, whereby one license is enough for consumption of all of the files originating from said content.

1- A method of facilitating and improving academic activities having the steps of:
setting up an Internet based exchange;
said exchange enabling a number of categories of academic players to perform academic activities;
said exchange enabling a set of said activities chosen from a list;
said list including at least, (a) suggesting a course of study, (b) designing a syllabus for a course, (c) teaching a course, (d) tutoring a course, (e) conducting a test, (t) taking a test, (g) proposing a research topic, (h) conducting research, (h) supervising a research, (i) examining a research and (j) conferring qualifications;
each player need not perform more than one of said activities;
said players need not be affiliated with a recognized establishment to perform a sub-list of above list;
said sub-list includes at least one of activities chosen from (a), (b) and (g); and
said set of activities include at least one from (a), (b) and (g).

2- Method of claim 1 where said activities list also includes at least (k) hosting of student transcripts, (l) hosting of other data related to a player or activity, (m) authentification of data provided by a player, (n) funding of a player or activity, (o) recruitment for a player or activity, (p) rating an activity or player and (q) accrediting a player or activity.

3- Method of claim 1 where said activities list also includes at least, (r) organizing off line or physical activities, (s) providing physical space for performance of off line activities, (t) providing a physical lab and (u) providing physical training facilities.

4- Method of claim 1 where a tutor's time slot is allocated to a limited number of students via a number of following methods:
auctioning said time slot between all student applicants
pricing said time slot high enough to reduce paying students to or below said limited number
setting criteria to reduce eligible student to or below said limited number.

5- Method of claim 1 where a number of players try to make financial gain from said activities.

6- Method of claim 1 executed via a system having a website, each of said players having a web accessing device, said players having access to said website via electronic communication links.

7- Method of claim 6 where a number of players are enabled to have direct communication with a number of other players, even off said website.

8- A method of delivering live and real time content from a source over the Internet to a receiver, having the steps of:
digitizing said content at source into separate time slots in real time sequence;
storing each slot into a dedicated file;
each file's size defined by a criterion chosen from a list, which list includes at least, (a) predetermined duration the file's live version takes, (b) a predetermined volume of digitized data it teh file, (c) the earlier that criterion “a” or “b” becomes true during digitizing and (d) the later that criterion “a” or “b” becomes true during digitizing;
providing a serial code signifying the order in real time the live version of said file occurred;
archiving said files;
delivering each file to the receiver via the Internet, using methods of delivering archived content;
ensuring that each file the can consumed only after a delay after it is received;
said delay is sufficient for each file to have been received before consuming said file starts;
which sufficiency is calculated from the delivery speeds prevailing during said content delivery;
ensuring that received files are consumed in the order their content occurred in real time; and
minimizing the time gap between ending consumption of one file and starting the next,
whereby content delivery is achieved lower costs and higher quality of achieved compared to live delivery, yet said delay is unnoticeable and the content appears live at consumption,
whereby a typical use of said method can be delivery of live lectures to students for improving academia.

9- Method of claim 8 where a license is needed to consume said received content, providing each of said with an identification code which is the same foe all files originating from said content, which license enables consumption of any file having said identification code, whereby one license is enough for consumption of all of the files originating from said content.
